(19) United States
(12) Patent Application Publication
(10) Pub. No.: US 2024/0356008 A1
(43) Pub. Date: Oct. 24, 2024

(54) PROCESS FOR THE PRODUCTION OF SILICON-CARBON COMPOSITE MATERIALS

(71) Applicant: ENWIRES, Montbonnot-Saint-Martin (FR)

(72) Inventor: Olga BURCHAK, Montbonnot-Saint-Martin (FR)

(73) Assignee: ENWIRES, Montbonnot-Saint-Martin (FR)

(21) Appl. No.: 18/687,966

(22) PCT Filed: Aug. 30, 2022
(86) PCT No.: PCT/EP2022/074124

§ 371 Date: Feb. 29, 2024

(30) Foreign Application Priority Data
Sep. 3, 2021 (EP) 21306207.8

(51) Int. Cl. H01M 4/36; H01M 4/02; H01M 4/04; H01M 4/1393; H01M 4/1395; H01M 4/38; H01M 4/587

(52) U.S. Cl. CPC H01M 4/364; H01M 4/0404; H01M 4/1393; H01M 4/1395; H01M 4/386; H01M 4/587; H01M 2004/021; H01M 2004/027

(57) ABSTRACT

A method for the preparation of a carbon-silicon composite material including nanostructured silicon and carbon-based material suitable for use as anode active material in lithium-ion batteries, the method includes deposition of nano-silicon on the surface of a carbon-based material by a chemical vapor deposition method and spheroidization of the obtained composite material.

The invention is directed to a method for the preparation of a silicon-carbon composite material comprising carbon-based material and nanostructured silicon. The invention is also directed to a method for making electrodes for lithium-ion batteries.

### STATE OF THE ART

Increasing the energy density of conventional lithium-ion batteries (LIBs) is important for satisfying the demands of electric vehicles and advanced electronics. Silicon is considered as one of the most-promising anode materials to replace the traditional graphite anode for the realization of high-energy LIBs due to its extremely high theoretical capacity, although its severe volume changes during lithiation/delithiation have led to a big challenge for practical application.

Such huge volume changes during electrochemical cycling will lead to repeated cracking and pulverization of silicon, and hence the disintegration and fracturing of the silicon electrode, accompanied by electrical isolation. The repeated cracking and pulverization will also lead to the continual breaking up of the solid electrolyte interphase (SEI) layer and the explosion of new surface, which will quickly consume the electrolyte and Li ions. Therefore, the use of sole silicon anode suffers from extremely fast capacity decay and low coulombic efficiency (CE) as a result of the severe volume changes and unstable SEI films.

Design strategies for advanced materials, such as employing unique nanostructures (nanowire, nanotube, core/shell, yolk shell, nanoporous materials, etc) and forming composites with carbon, conductive polymer, and so forth, have been applied as academic approaches to significantly improve the cycle life of LIBs. Nevertheless, the volumetric energy density of these materials and the areal mass loading on electrodes are generally too low for industrial implementation. The commercial goal of achieving high-performance anodes to replace the existing commercial graphite materials in the near future, involves reaching a specific capacity between 500 mAh/g and 1000 mAh/g with a capacity retention of 80% after 500-1000 cycles, while the initial CE and average CE should exceed 90% and 99.8%, respectively. Accordingly, the pressing density should reach ˜1.65 g/cm³, and electrode swelling should be restricted to ˜10%.

Recently, the co-utilization of silicon and graphite has emerged as the most practical anode material for high-energy LIBs. Graphite is a commercial anode with low cost, high CE, excellent cycle life, good mechanical flexibility, minor volume change, and high electrical conductivity. The addition of silicon into graphite can buffer the volume change, increase the electric conductivity, and achieve high specific, areal and volumetric capacities at the same time. Moreover, the co-utilization of silicon and graphite can use the same commercial production lines, translating into high manufacturability and minimal investment. Therefore, the co-utilization hybridizes two distinct anodes on the materials level into a single composite, retaining the advantages while circumventing the disadvantages of both, and can secure its success in the anode market.

There are two main types of silicon-graphite composites: graphite particles covered by silicon (nanoparticles, nanowires, etc) (i.e., primary particles)^{[1]} and silicon embedded into graphite matrix (i.e., secondary particles). The first type is not relevant enough since it has the same drawbacks as nano-silicon (high surface area, unstable SEI, low ICE and following CEs, low composite density, etc). The second type is much more appropriate as the particles have similar properties as graphite microparticles (low surface area, stable SEI, high ICE and following CEs, high tap and pressing density).

Various synthetic methods exist to design silicon-graphite composites wherein silicon is embedded inside the graphite material. For example, Sui et al^{[2]} used a multi-step procedure, mainly including dry/wet ball milling, spray drying, and carbonization to form a Si-graphite composite with silicon inside the graphite particles. The authors use a lot of carbonaceous materials favourable for cycling stability but detrimental to initial CE. Liu et al.^{[3]} designed Si-graphite composite with nano-silicon encapsulated in the conductive graphite flakes/amorphous carbon framework. The process consists in five synthetic steps, demands inert conditions and rare/expensive reagents. The final composites demonstrated low ICE (47-68%) and following CEs that remain lower than 99%. Wang et al.^{[4]} reported a silicon/carbon/natural graphite composite, prepared by the granulation of natural graphite and silicon/poly (acrylonitrile-co-divinylbenzene) microspheres via spray drying and subsequent pyrolysis. Through micro-suspension polymerization, nanoparticles of silicon were encapsulated in cross-linked poly (acrylonitrile-co-divinylbenzene) microspheres. The composite showed an initial coulombic efficiency of 78% and a capacity retention of 88% after 100 cycles against Li-metal as negative electrode. The composite could thus not be used in commercial batteries for technical and economic reasons.

The advantages of the previous methods are engineering of micrometer-sized hierarchical structures and a suitable morphology with proper controls on distribution of components, conductive networks, sizes, voids, shells. These structures would lead to competitive performance in terms of energy density. However, the three first examples cannot be transposed on an industrial scale production of silicon-graphite composites for battery industry.

During the last two decades, some efforts have been made to find more industrial methods to produce silicon-graphite composites shaped as micrometric secondary particles. In 2006, Uono et al^{[5]} reported a “surface-coat-type” composite of silicon, carbon (pitch), and graphite, fabricated by a milling process and heat treatment. They concluded that the small particle size of Si (100 nm) and the large particle size of graphite (30 μm) were beneficial for decreasing the composite's surface area, leading to low irreversible specific capacity. The main step of their method was a simple mixing of silicon powders, pitch coke powders and graphite powders to form several types of micrometric secondary particles using several versions of mixing step. However, all versions of the method require the use of ethanol as organic solvent. Another drawback is a limited cyclability of synthesized composites as a major part of silicon nanoparticles is located on the surface of graphite/carbon/silicon composite.

In 2008, Lee et al.^{[6]} designed spherical nanostructured silicon/graphite/carbon composite by pelletizing a mixture of nano-silicon/graphite/petroleum pitch powders, followed by heat treatment at 1000° C. under argon atmosphere. The resultant composite sphere consists of nanosized silicon and flaked graphite embedded in a carbon matrix pyrolyzed from petroleum pitch, in which the flaked graphite sheets are concentrically distributed in a parallel orientation. The composite presented a reversible capacity of 700 mAh/g and a good initial CE (86%). The main drawbacks of this method are the use of solvent-based treatments and the multiple steps as well as limited cyclability of the final composites.

In 2010, Jo et al.^{[7]} compared two types of composites (Si-Graphite-Pitch): in one case, the silicon particles are on the surface of graphite (type A), and in the other, the silicon particles are embedded in the graphite/carbon matrix (type B). It was found that the charge (657 mAh/g) and discharge (568 mAh/g) capacities of type B were both higher than for type A, but these two types had the same cycling CEs. The process is solvent-free and simple. However, the final composites show a non-homogeneous dispersion of silicon nanoparticles inside the secondary particles (large agglomerates of 500-1000 nm) that resulted in poor cyclability.

Therefore, even efforts to use industrial methods to produce silicon-graphite composites as anode materials for Li-ion batteries have led to processes which are too expensive and not convenient for large scale production. One of the main problems is the difficulty to disperse silicon homogeneously on the graphite without the use of solvent.

KR2020/0095017 and US2021/013499 describe a method for preparing an electrode active material, the method comprising forming a coating layer containing silicon on a plate-shaped graphite material and reassembling the plate-shaped silicon-coated graphite by grinding or polishing through a mechanical device so that the silicon coating layer deposited on the outside of the plate-shaped graphite material moves to the inside of the final graphite material. The method uses graphite sheets having a very small size, i.e., of about 4 μm. The first disadvantage is that this method does not allow a satisfying control of the porosity and a necessary cyclability of the final silicon-graphite material. In addition, the nano-silicon layer deposition on the highly fines graphite powder is difficult to achieve especially at large (industrial) scale. For this reason, the amount of silicon that is embedded inside the graphite material is limited.

The battery industry still needs to integrate silicon and graphite into a single system/composite to obtain the desired design: micrometric silicon-graphite particles with homogeneous dispersion of silicon, controlled internal porosity to accommodate silicon expansion during the material cycling, low surface area and acceptable pressing anode density using a simple, low-cost and easily scaled-up production process.

To achieve the above object, the present invention provides a simple method that can be easily scaled-up. Said method gives access to a special secondary particle design from flakes of carbon-based material and nanostructured silicon material in only two steps: deposition of nano-silicon on the surface of the carbon-based material by a chemical vapor deposition (CVD) method and spheroidization of the obtained composite material. Thanks to a specific choice of material, in particular the carbon-based material and/or the presence of a catalyst, the method according to the invention results in a final silicon-carbon-based material whose properties are better controlled.

### SUMMARY OF THE INVENTION

A first object of the invention consists in a method for the preparation of a carbon-silicon composite material, wherein the method comprises:
a) introducing into a chamber of a reactor at least: flakes of a carbon-based material and optionally a catalyst,
b) introducing into the chamber of the reactor at least a precursor compound of nanostructured silicon,
c) decreasing the dioxygen content in the chamber of the reactor,
d) applying a thermal treatment at a temperature ranging from 200° C. to 900° C.,
e) recovering a first silicon-carbon composite material,
f) applying a spheroidization step to the product obtained in step (e) to obtain a second silicon-carbon composite material.

According to a first aspect, the method according to the invention comprises:
a) introducing into a chamber of a reactor at least: flakes of a carbon-based material having a particle size D50 of from 25 μm to 500 μm,
b) introducing into the chamber of the reactor at least a precursor compound of nanostructured silicon,
c) decreasing the dioxygen content in the chamber of the reactor,
d) applying a thermal treatment at a temperature ranging from 200° C. to 900° C.,
e) recovering a first silicon-carbon composite material,
f) applying a spheroidization step to the product obtained in step (e) to obtain a second silicon-carbon composite material.

According to a second aspect, the method according to the invention comprises:
a) introducing into a chamber of a reactor at least: flakes of a carbon-based material and a catalyst,
b) introducing into the chamber of the reactor at least a precursor compound of nanostructured silicon,
c) decreasing the dioxygen content in the chamber of the reactor,
d) applying a thermal treatment at a temperature ranging from 200° C. to 900° C.,
e) recovering a first silicon-carbon composite material,
f) applying a spheroidization step to the product obtained in step (e) to obtain a second silicon-carbon composite material.

According to a third aspect, the method according to the invention comprises:
a) introducing into a chamber of a reactor at least: flakes of a carbon-based material having a particle size D50 of from 25 μm to 500 μm and a catalyst,
b) introducing into the chamber of the reactor at least a precursor compound of nanostructured silicon,
c) decreasing the dioxygen content in the chamber of the reactor,
d) applying a thermal treatment at a temperature ranging from 200° C. to 900° C.,
e) recovering a first silicon-carbon composite material,
f) applying a spheroidization step to the product obtained in step (e) to obtain a second silicon-carbon composite material.

According to a favourite embodiment of any aspect of the invention,, in the first silicon-carbon composite material, the average ratio of the surface of the carbon-based material covered by nanostructured silicon is 50% or more, preferably 70% or more, more preferably 80% or more.

According to a favourite embodiment of any aspect of the invention, in the second silicon-carbon composite material, the average ratio of the external surface of the material covered by nanostructured silicon is 20% or less, preferably 10% or less, more preferably 5% or less.

According to a first variant of any aspect of the invention, steps (a) to (e) are implemented in a tumbler reactor set in motion by a rotating and/or a mixing mechanism.

According to a second variant of any aspect of the invention, steps (a) to (e) are implemented in a fixed-bed reactor.

According to a third variant of any aspect of the invention, steps (a) to (e) are implemented in a vertical fluidized bed reactor.

According to a favourite embodiment of any aspect of the invention, the spheroidization step (f) comprises at least a step selected from milling, grinding, compacting, densifying, compressing, pressing, folding, winding, rolling, crashing, coarsing, pulverizing, centrifuging or a mixture of one or more of these steps.

According to a favourite embodiment of any aspect of the invention, at least part of the second silicon-carbon composite material is in the form of micrometric particles having a D50 between 5 and 50 μm.

According to a favourite embodiment of any aspect of the invention, the micrometric particles of the second silicon-carbon composite material have a potato-like shape.

According to a favourite embodiment of any aspect of the invention, the micrometric particles of the second silicon-carbon composite material have a specific surface area of 20 m²/g or less, preferably 10 m²/g or less, more preferably 5 m²/g or less.

According to a favourite embodiment of the first and/or the third aspect of the invention, the second silicon-carbon composite material has an internal porosity of from 5% to 25%.

According to a favourite embodiment of any aspect of the invention, the carbon-based material is selected from graphite, graphene, carbon.

Preferably, the carbon-based material is graphite.

Advantageously, the graphite is natural graphite or artificial graphite.

According to a favourite embodiment of any aspect of the invention, the precursor compound of the silicon particles is a silane compound or a mixture of silane compounds, preferably diphenylsilane.

When a catalyst is used, the catalyst is advantageously chosen from metals, metallic oxides and metallic halides. Preferably, the catalyst is selected from gold (Au), tin (Sn), tin dioxide (SnO₂), tin halide (SnX₂) and mixtures thereof.

According to the first aspect of the invention, the nanostructured silicon is advantageously in the form of nanoparticles, preferably nanoparticles having a diameter ranging from 1 nm to 250 nm.

According to the second and/or the third aspect of the invention, the nanostructured silicon is advantageously in the form of nanowires or nanofibers, preferably nanowires having a diameter ranging from 1 nm to 250 nm. According to a favourite embodiment of any aspect of the invention, the method according to the invention further comprises after step (f), a step of coating the outer surface of the second material by a second carbon material, different from the flakes of carbon-based material.

Another object of the invention is a method of making an electrode including a current collector, said method comprising (i) preparing a carbon-silicon composite material according to any aspect of the method described above and in details here-under, as an electrode active material, and (ii) covering at least one surface of the current collector with a composition comprising said electrode active material.

Another object of the invention is a method of making an energy storage device, like a lithium secondary battery, including a cathode, an anode, and a separator disposed between the cathode and the anode, wherein at least one of the electrodes, preferably the anode, is obtained by the method for the preparation of a carbon-silicon composite material as disclosed above and in details here-under.

Compared with prior art anode material preparation methods, the present invention provides the following advantages:
the preparation method is simple, easy to scale-up, environmentally friendly, and low cost;
the second silicon-carbon composite material has good particle morphology, controlled internal porosity and low surface area;
silicon is homogeneously dispersed in the silicon-carbon composite material;
after chemical vapor deposition (CVD), the nanostructured silicon is attached to the surface of the carbon-based material which allows improved processability of the first silicon-carbon-based material;
the second silicon-carbon composite material has much higher columbic efficiencies (CE) and consequently improved cyclability;
the entire process is based on microparticles processing with nanostructured silicon attached to the carbon-based material, which means that this process presents minimal risk associated to the nanostructured materials.

### DETAILED DESCRIPTION

The term “consists essentially of” followed by one or more characteristics, means that may be included in the process or the material of the invention, besides explicitly listed components or steps, components or steps that do not materially affect the properties and characteristics of the invention.

The expression “comprised between X and Y” includes boundaries, unless explicitly stated otherwise. This expression means that the target range includes the X and Y values, and all values from X to Y.

The invention firstly relates to a method for the production of silicon-carbon composite material comprising nanostructured silicon material and a carbon-based material, the silicon-carbon composite material being suitable for use as anode active material in lithium-ion batteries.

By “composite material”, we refer to a material made of at least two constituent materials with significantly different physical or chemical properties.

The term “nanostructured material” is understood to mean, within the meaning of the invention, a material containing free particles, possibly in the form of aggregates or in the form of agglomerates, wherein at least 5% by weight, preferably at least 10% by weight of said particles, with respect to the total weight of the material, have at least one of their external dimensions ranging from 1 nm to 500 nm, preferably from 1 to 100 nm.

The external dimensions of the particles may be measured by any known method and notably by analysis of images obtained by scanning electron microscopy (SEM) of the composite material according to the invention.

Particularly, the invention relates to a method for the production of silicon-carbon composite material said method comprising:
a) introducing into a chamber of a reactor at least: flakes of a carbon-based material and optionally a catalyst,
b) introducing into the chamber of the reactor at least a precursor of nanostructured silicon,
c) decreasing the dioxygen content in the chamber of the reactor,
d) applying a thermal treatment at a temperature ranging from 200° C. to 900° C.,
e) recovering a first silicon-carbon composite material wherein nanostructured silicon is disposed on the flakes of carbon-based material,
f) applying a spheroidization step to the product obtained in step e) to obtain a second silicon-carbon composite material wherein at least part of the nanostructured silicon is embedded in the carbon-based material.

According to a first aspect, in step a) of the method according to the invention, at least part of, and preferably all, flakes of a carbon-based material have a particle size D50 of from 25 μm to 500 μm.

According to a first aspect, in step a) of the method according to the invention a catalyst is introduced into the chamber of the reactor.

According to a third aspect, which consists of the combination of the two aspects mentioned above, in step a) of the method according to the invention, at least part of, and preferably all, flakes of a carbon-based material have a particle size D50 of from 25 μm to 500 μm and a catalyst is introduced into the chamber of the reactor.

It should be noted that the three aspects of the invention differ only with respect to step a) of the method according to the invention. In the following disclosure, the description of steps b) to f) as well as possible additional steps, applies to all three aspects.

For the purpose of this invention, throughout the following description, the carbon-based material, the catalyst and the precursor of nanostructured silicon are referred to as “the starting materials” and the first and the second silicon-carbon composite materials are referred to as “the obtained composite materials”. The first silicon-carbon composite material is referred to as “the intermediary silicon-carbon composite material” or as “primary particles”, and the second silicon-carbon composite material is referred to as “the final silicon-carbon composite material” or as “secondary particles”. Some characteristics are common to the first and the second silicon-carbon composite material. They are referred to as characteristics of the obtained composite materials.

A second object of the invention consists in a method for the production of an electrode active material comprising the final silicon-carbon composite material obtained by the method according to the invention and an energy storage device comprising the same.

### The Starting Materials

### The Carbon-Based Material

The method according to the invention comprises the use as a starting material of flakes of a carbon-based material.

Unless otherwise specified, in the following description of the carbon-based material, the preferred embodiments apply to all aspects of the invention.

As used herein a “carbon-based material” refers to a material that comprises at least 50% by weight, preferably at least 70% by weight, more preferably 80% carbon, more preferably still 90% by weight and most preferably 100% by weight of carbon.

According to the invention, the carbon-based material is used as support for the growth/deposition of nanostructured silicon.

The term “flakes” is understood to mean, within the meaning of the invention, a lamella or scaly form thin piece of carbon-based material having a thickness of from several nanometers to a few micrometers and which has two major sides having approximately the same size.

Flakes of carbon-based material can be used in mixture with carbon-based materials of different shapes, such as, for example, platelets, needles, ribbons, tubes, and continuous or chopped fibers. Preferably, flakes of carbon-based material represent at least 50% by weight, advantageously, at least 70% by weight, more preferentially at least 90% by weight, better at least 95% by weight, and very preferentially at least 99% by weight of carbon-based material used in the method according to the invention. Preferably, the carbon-based material is essentially constituted of flakes of carbon-based material and more preferably is solely constituted of flakes of carbon-based material.

The carbon-based material may be any material selected from the group consisting of graphite, graphene and carbon. More specifically, the carbon-based material may be selected from, for example, natural graphite, artificial graphite, hard carbon, soft carbon, graphene or a mixture of two or more thereof.

According to a favorite embodiment, the carbon-based material is selected from graphene, artificial graphite and natural graphite.

Preferably, the carbon-based material is selected from natural and artificial graphite.

Natural graphite is obtained from naturally sourced graphite material and occurs as amorphous graphite, flake graphite or vein graphite. Artificial graphite is a manufactured product made by high-temperature treatment of amorphous carbon materials such as for example graphitization of petroleum coke and coal tar pitch.

Preferably, at least 75% by weight of the carbon-based material is constituted of natural and artificial graphite, more preferably at least 80% by weight, still more preferably at least 90% by weight, even more preferably at least 95% by weight, and advantageously at least 99% by weight, with respect to the total weight of the carbon-based material.

Preferably, the carbon-based material is essentially constituted of natural or artificial graphite, and more preferably is solely constituted of natural or artificial graphite.

Advantageously, the carbon-based material, preferably graphite, has a purity of 95%, preferably 98% or more, and more preferably 99% or more. Purity can be determined by comprehensive tests such as chemical analysis by ICP-OES or equivalent for measuring metallic trace elements, XRD, Raman spectroscopy and precise weighting for estimating the ordering/disordering and the relative proportion of graphite.

Preferably, the flakes of the carbon-based material have a thickness of from 100 nm to 50 μm, preferably from 200 nm to 20 μm, more preferably from 500 nm to 10 μm.

Preferably, the flakes of the carbon-based material have a planar morphology with an aspect ratio of average length to thickness of from 2 to 2000, preferably from 2 to 500, more preferably from 2 to 100 and even more preferably from 2 to 50.

Advantageously, the carbon-based material has a tap density from 0.01 to 2 g/cm³, preferably from 0.02 to 1 g/cm³ and more preferably from 0.03 to 0.5 g/cm³.

According to an embodiment which applies particularly to the second aspect of the invention, the flakes of the carbon-based material have advantageously a particle size D50 of from 1 μm to 800 μm, preferably from 1 μm to 500 μm, more preferably from 10 to 100 μm.

According to the first and the third aspect of the invention the flakes of the carbon-based material have a particle size D50 ranging from 25 μm to 500 μm, preferably from 30 μm to 500 μm, more preferably from 30 μm to 100 μm, most preferably from 35 μm to 50 μm. Preferably, according to the first and the third aspect of the invention, flakes of carbon-based material with a particle size D50 ranging from 25 μm to 500 μm represent at least 50% by weight, advantageously, at least 70% by weight, more preferentially at least 90% by weight, better at least 95% by weight, and very preferentially at least 99% by weight of carbon-based material used in the first and the third aspect of the method according to the invention.

The applicant has found that the use of relatively large flakes of carbon-based material, in particular of graphite, according to these aspects, allows better control of the internal porosity of said material. It results therefrom an optimization of the amount of nanostructured silicon embedded inside the carbon-based material.

The particle size D50 of the flakes may be measured by techniques known to the skilled professional such as, for example, using a laser diffraction method or standard sieves.

### The Catalyst

The method according to the invention optionally comprises the introduction into the chamber of the reactor of at least one catalyst. The characteristics here-under, especially the characteristics designated as favourite, relate to the case wherein this catalyst is present in the method according to the invention, in particular according to the second and the third aspects.

The function of the catalyst is to create growth sites on the surface of the carbon-based material.

Preferably, the catalyst is chosen from metals, bimetallic compounds, metallic oxides, metallic halides, metallic nitrides, metallic salts, metallic sulphides and organometallic compounds.

Among metal catalysts, one can mention gold (Au), cobalt (Co), nickel (Ni), bismuth (Bi), tin (Sn), iron (Fe), indium (In), aluminium (Al), manganese (Mn), iridium (Ir), silver (Ag), copper (Cu), calcium (Ca) and mixtures thereof.

Among bimetallic compounds, mention may be made of manganese and platinum MnPt₃, or iron and platinum FePt.

Among metallic sulphides, mention may be made of tin sulphide SnS.

Among metallic oxides, mention may be made of ferric oxide Fe₂O₃ and tin oxide SnO₂₋ₓ (0≤x<2).

Among metallic halides, mention may be made of tin halides SnX₂ wherein X a halide selected from the group consisting of F, Cl, Br and I.

More preferably, the catalyst is chosen from metals, metallic oxides and metallic halides.

Preferably, the catalyst is selected from gold (Au), tin (Sn), tin dioxide (SnO₂), tin halide (SnX₂) and mixtures thereof.

According to a first favourite embodiment of the invention, the catalyst is gold (Au). For example, gold nanoparticles that may be used in the process according to the invention are disclosed in M. Brust et al., J. Chemical Society, Chemical Communications, 7 (7): 801-802, 1994.

According to a second favourite embodiment, the catalyst is tin (II) chloride SnCl₂.

Preferably, the catalyst is under the form of particles, more preferably under the form of nanoparticles.

Preferably, the longest dimension of the catalyst nanoparticles ranges from 1 nm to 100 nm, more preferably from 1 nm to 50 nm, and still more preferably from 5 nm to 30 nm.

Advantageously, the catalyst nanoparticles are spherical.

According to a favourite embodiment, the catalyst is under the form of nanometric spherical particles with a diameter ranging from 1 to 30 nm, preferably from 5 nm to 30 nm.

Preferably, the catalyst and the carbon-based material are used according to a mass ratio catalyst/carbon-based material ranging from 0.01 to 1, more preferably from 0.02 to 0.5, and still more preferably from 0.05 to 0.15.

The catalyst and the carbon-based material may be or may not be in contact before their introduction into the chamber of the reactor.

According to a preferred embodiment, the carbon-based material and the catalyst are associated before their introduction into the reactor.

For the purposes of the invention, the term “associated” is intended to mean that the carbon-based material and the catalyst have previously undergone a mixing step corresponding to the attachment or deposition of at least a portion of the catalyst on at least part of the surface of the carbon-based material.

The association of the catalyst with the carbon-based material allows the formation of a plurality of particles growth sites on the surface of the carbon-based material.

Advantageously, the carbon-based material bears catalyst particles on its surface. Preferably, according to a favourite embodiment, the catalyst nanoparticles are uniformly dispersed on the surface of the flakes of the carbon-based material.

In case the method comprises the use of a SnX₂ catalyst, the combination of SnX₂, preferably SnCl₂, and the carbon-based material is simple and robust. SnCl₂, like the other tin halides, being a very stable product allows an easier processing compared to other catalysts. Indeed, SnCl₂, like the other tin halides, only requires solid/solid mixing with the carbon-based material, whereas the use of gold nanoparticles requires a solid/liquid preparation followed by an evaporation of solvents.

The combination of SnX₂, preferably SnCl₂, and the carbon-based material can be implemented with any industrial mixing apparatus known to the skilled professional such as ball-milling, attrition-milling, hammer milling, high energy milling, pin-milling, turbo-milling, fine cutting milling, impact milling, fluidized bed milling, conical screw milling, rotor milling, agitated bead milling, or jet milling. This step does not take more than 30 minutes and can be made neat or with any solvent from aqueous to organic without limitation.

### The Precursor of the Nanostructured Silicon

The process according to the invention comprises the introduction into the chamber of the reactor of at least one precursor compound of the nanostructured silicon. By “precursor compound of nanostructured silicon”, we refer to a compound capable of forming silicon nanostructured materials by implementing the method according to the invention, especially a compound capable of forming nanostructured silicon materials under CVD process conditions.

This compound can be introduced into the chamber of the reactor as a liquid or as a gas. When the compound is introduced into the chamber of the reactor as a liquid, it is transformed to the gas state in the reactor chamber, by controlling the temperature and the pressure in the chamber of the reactor. When the precursor compound of nanostructured silicon is in a gas state, it is designated «reactive silicon-containing gas species».

For example, if the precursor compound of nanostructured silicon is a liquid, such as for example diphenylsilane, when the reactor reaches appropriate temperature/pressure parameters, the liquid precursor evaporates to a gas species.

The precursor compound of nanostructured silicon can be introduced into the reactor as a gas in mixture with a carrier gas or a pure precursor gas.

If the precursor compound is in the form of a reactive silicon-containing gas species, it can be introduced into the chamber of the reactor in mixture with a carrier gas (forming a reactive silicon-containing gas mixture). For example, SiH₄, a gas at ambient temperature/pressure, can be introduced directly into the chamber of the reactor alone or in mixture with a carrier gas. Alternately, a liquid precursor compound such as diphenylsilane, Ph₂SiH₂, can be heated to be transformed to the vapor state in a preliminary stage of the method and then be introduced into the chamber of the reactor as a gas, alone or in mixture with a carrier gas.

By “carrier gas”, we refer to a gas that is chosen from a reducing gas, an inert gas, or a mixture thereof. Preferably, the reducing gas is hydrogen (H₂). Preferably, the inert gas is chosen from argon (Ar), nitrogen (N₂), helium (He), or a mixture thereof.

According to a preferred embodiment, the silicon-containing gas mixture is composed of at least 1% by volume of silicon-containing gas species, preferably at least 10% by volume, more preferably at least 50% by volume, still more preferably 100% by volume. The proportions of silicon-containing gas species and carrier gas can be modulated at different levels at different steps of the process.

Preferably, the precursor compound of nanostructured silicon, or «reactive silicon-containing gas species», is a silane compound or a mixture of silane compounds.

For the purpose of the invention, the term “silane compound” refers to compounds of formula (I):

$${R}_{1} - {( {Si R}_{2} {R}_{3} )}_{n} - {R}_{4} \qquad ( I )$$

wherein:
n is an integer ranging from 1 to 10, and
R₁, R₂, R₃ and R₄ are independently chosen from hydrogen, C1-C15 alkyl groups, C6-C12 aryl groups, C7-C20 aralkyl groups and chloride.

According to this embodiment, preferably, the silicon-containing gas species is chosen from compounds of formula (I) wherein:
n is an integer ranging from 1 to 5, and
R₁, R₂, R₃ and R₄ are independently chosen from hydrogen, C1-C3 alkyl groups, phenyl, and chloride.

Even more preferably, n is an integer ranging from 1 to 3, and R₁, R₂, R₃ and R₄ are independently chosen from hydrogen, methyl, phenyl, and chloride.

According to this embodiment, preferably, the precursor compound of nanostructured silicon is chosen from silane, disilane, trisilane, chlorosilane, dichlorosilane, trichlorosilane, dichlorodimethylsilane, phenylsilane, diphenylsilane or triphenylsilane or a mixture thereof.

According to a preferred embodiment, the precursor compound of nanostructured silicon is silane (SiH₄) or diphenylsilane Si(C₆H₅)₂H₂. The nature and physical state of the precursor compound of nanostructured silicon is selected according to the type of reactor and the other parameters of the method.

According to a most preferred embodiment, the precursor compound of nanostructured silicon is diphenylsilane Si(C₆H₅)₂H₂. Indeed, the presence of phenyl groups in diphenylsilane can be a source of amorphous carbon inside the second silicon-carbon composite material which significantly improves the electrical conductivity of the composite material during cycling.

### Doping Material

According to one embodiment, the method according to the invention comprises the introduction into the reactor, of at least one doping material.

The term “doping material” is understood to mean, within the meaning of the invention, a material capable of modifying the conductivity properties of the silicon. A doping material within the meaning of the invention is, for example, a material rich in phosphorus, boron or also nitrogen atoms.

Preferably, and according to this embodiment, the doping material is introduced into the chamber of the reactor by means of a precursor chosen from diphenylphosphine, triphenylborane and di- and triphenylamine. According to a first variant, this introduction is implemented before the growth of nanostructured silicon has started. For example, the doping material may be introduced into the chamber of the reactor after step (b) and before step (c).

According to another variant, the precursor of the doping material is introduced as a gas simultaneously with (and possibly as part of) the reactive silicon-containing gas mixture.

Preferably, the molar proportion of doping material, with respect to the precursor compound of the nanostructured silicon, is from 10⁻⁴ mol % to 10 mol %, preferably from 10⁻² mol % to 1 mol %.

### The Method for the Production of the Carbon-Silicon Composite Material

The method according to the invention comprises:
a) introducing into a chamber of a reactor at least: flakes of a carbon-based material and optionally, a catalyst,
b) introducing into the chamber of the reactor at least a precursor of nanostructured silicon,
c) decreasing the dioxygen content in the chamber of the reactor,
d) applying a thermal treatment at a temperature ranging from 200° C. to 900° C.,
e) recovering a first silicon-carbon composite material wherein nanostructured silicon is disposed on the flakes of carbon-based material,
f) applying a spheroidization step to the product obtained in step e) to obtain a second silicon-carbon composite material wherein at least part of the nanostructured silicon is embedded in the carbon-based material.

In particular, step a) can be implemented according to any of the first, second or third aspect which have been detailed above and in the experimental part.

### Steps (a) to (e)

The order of steps (a) to (d) can be the recited order or another order, depending essentially on: the characteristics of the reactor in which the method is implemented, the method for reducing dioxygen content and the state (liquid or gaseous) in which the precursor compound of the nanostructured silicon is introduced into the reactor.

### Method Parameters

The process according to the invention comprises (a) the introduction of a carbon-based material into the chamber of the reactor and optionally a catalyst.

According to a favourite variant, the process according to the invention comprises a preliminary step of associating the carbon-based material with the catalyst. According to this variant, the catalyst and the flakes of carbon-based material are mixed together before their introduction into the reactor.

Preferably, the loading ratio by volume of the mixture of the carbon-based material and the catalyst, based on the volume of the chamber of the reactor, is from 10% to 60%, more preferably from 20% to 50%, still more preferably from 30% to 50%.

Step (c) consisting in decreasing the dioxygen content in the chamber of the reactor can be performed by different methods. Decreasing the dioxygen content in the chamber of the reactor can be implemented by placing the reactor under vacuum, preferably to a pressure inferior or equal to 10⁻¹ bar (10⁻² MPa). Alternately, decreasing the dioxygen content in the chamber of the reactor can be performed by washing the chamber of the reactor with an inert gas.

In the context of the invention, the expression “washing the chamber of the reactor with an inert gas” means that an inert gas flow is injected into the chamber of the reactor in order to replace the gas present in the reactor by the injected inert gas.

Preferably, the inert gas is chosen from dinitrogen N₂, Argon Ar, and mixtures thereof.

In case the reactor is a closed reactor, preferably, the chamber of the reactor is washed at least twice, more preferably at least 3 times with inert gas.

In case the reactor is an open reactor, the inert gas can flow through the chamber of the reactor during all or part of the process.

Preferably, at the end of step (c), the dioxygen content in the chamber of the reactor is inferior or equal to 1% by volume, with respect to the total volume of the chamber of the reactor.

Preferably, the thermal treatment is performed at a temperature ranging from 200 to 900° C., preferably from 300° C. to 700° C., even more preferably from 300° C. to 600° C.

Preferably, the thermal treatment is performed under low pressure, atmospheric pressure or pressure ranging from 0.11 to 30 MPa, the pressure parameter being governed by the choice of the type of reactor and the open or closed status of the reactor.

During the process according to the invention, and because of the thermal treatment, the pressure in the reactor may increase. This internal pressure depends on the thermal treatment that is applied and is not necessarily controlled or monitored.

Preferably, the thermal treatment is applied from 1 minute to 5 hours, preferably from 10 minutes to 2 hours, and more preferably from 30 minutes to 60 minutes.

According to a variant embodiment, the process according to the invention comprises a post-treatment step, between steps (d) and (e), in order to transform organics into carbon materials. When it is implemented, this step consists essentially of a thermal treatment. Advantageously, this step is performed under inert atmosphere, under a carrier gas atmosphere, such as for example N₂, Ar, a mixture of Ar/H₂, at a temperature ranging from 500 C to 700° C., preferably from 550° C. to 650° C., advantageously around 600° C.

According to a variant, the process according to the invention comprises an additional step (e′) of washing the first silicon-carbon composite material obtained at the end of step (e).

The first silicon-carbon composite material obtained at the end of step (e) can be washed with an organic solvent, preferably chosen from: chloroform, ethanol, toluene, acetone, dichloromethane, petroleum ether and mixtures thereof.

Alternately, according to a favorite embodiment, the first silicon-carbon composite material obtained at the end of step (e) is washed with an acid solution.

According to this variant, preferably, after step (e′), the process further comprises a supplementary step of drying the washed composite material.

Drying is for example performed by placing the first silicon-carbon composite material into an oven, preferably at a temperature superior or equal to 40° C., more preferably superior or equal to 60° C. Preferably, the drying step lasts from 15 minutes to 12 hours, more preferably from 2 hours to 10 hours, and even more preferably from 5 hours to 10 hours.

### The Reactor

According to a first variant, the method according to the invention is implemented in a fixed-bed reactor.

According to a second variant, the method according to the invention is implemented in the tubular chamber of a tumbler reactor comprising a rotating and/or a mixing mechanism.

According to a third variant, the method according to the invention is implemented in a (vertical) fluidized bed reactor.

According to a first embodiment, the reactor is closed during the process.

According to a second embodiment, the reactor is open during the process.

By open reactor is meant the reactor remains open to gas flow during the implementation of the method, especially during the thermal treatment step. By closed reactor is meant the introduction of gaseous species into the reactor is achieved at the beginning of the process and then the reactor is closed to gas flow during the thermal treatment step.

### First Variant

According to a first variant, the method according to the invention is implemented in a fixed-bed reactor.

### Characteristics of the Reactor

The fixed-bed reactor can be an open reactor or a closed reactor.

A reactor which can be used to implement the method according to the invention is disclosed for example in WO2019020938. In this document, it is used in the “closed reactor” mode.

According to an alternate embodiment, an open fixed bed reactor is used to implement the method according to the invention. Such a reactor is for example the tubular chamber of a tumbler reactor which is used in a static mode (without rotation or mixing).

### Parameters

According to this first variant, in case the reactor is closed, decreasing the dioxygen content in the chamber of the reactor can be performed by placing the reactor under vacuum, preferably to a pressure inferior or equal to 10⁻¹ bar (10⁻² MPa).

Alternately, decreasing the dioxygen content in the chamber of the reactor can be performed by washing the chamber of the reactor with an inert gas.

Preferably, the inert gas is chosen from dinitrogen N₂, Argon Ar, and mixtures thereof. In case the reactor is closed, preferably, the chamber of the reactor is washed at least twice, more preferably at least 3 times with inert gas. In case the reactor is open, the inert gas can flow through the chamber of the reactor during all or part of the process.

Preferably, at the end of step (c), the dioxygen content in the chamber of the reactor is inferior or equal to 1% by volume, with respect to the total volume of the chamber of the reactor.

According to the first embodiment of this variant, when the reactor is closed, generally the precursor compound of the nanostructured silicon is introduced into the reactor as a liquid.

According to the first embodiment of this variant, when the reactor is closed, the carbon-based material, the catalyst and the precursor compound of the nanostructured silicon can be introduced into the reactor in the form of a mixture.

According to the first embodiment of this variant, when the reactor is closed, preferably the reactor comprises at least two charging zones, a first zone which makes it possible to receive the precursor compound of the nanostructured silicon and a second zone which makes it possible to receive the carbon-based material and the catalyst.

According to a first alternative form, the first charging zone and the second charging zone are located at the same level in the chamber of the reactor.

According to a preferred alternative form, the second charging zone is raised with respect to the first charging zone.

According to a second embodiment of this variant, when the reactor is open, generally the precursor compound of the nanostructured silicon is introduced into the reactor as a gas in mixture with an inert gas, designated “reactive silicon-containing gas mixture”.

### Second Variant

According to a second variant, the method according to the invention is implemented in the tubular chamber of a tumbler reactor comprising a rotating and/or a mixing mechanism.

### Characteristics of the Reactor

The tumbler reactor here-above mentioned is composed of at least a tubular chamber, heated by a furnace, in which the carbon-based material can be loaded. The reactor integrates a rotating mechanism and/or a mixing mechanism. The reactor can comprise two tubular chambers. The tubular chamber longitudinal axis is horizontal or can be tilted to make an angle with the horizontal axis up to 20°. The reactor further comprises a product feeding system and a product discharge system, allowing a semi-continuous production of the first silicon-carbon composite material. The tumbler reactor comprises a reactor pressure control device, like for example a needle valve, or a pressure controller.

A typical mechanical tumbler reactor is a Lödige's type fluidized-bed reactor, where fluidization is generated by the rotation of a horizontal axis helix in the tubular chamber.

Another typical mechanical tumbler reactor comprises a rotating tubular chamber where fluidization is generated by the rotation of the tubular chamber around its longitudinal axis.

### Parameters

This variant is of particular interest for the implementation of the method according to the invention, fluidization mechanically generated by the reactor being beneficial to the contact between the carbon-based material and the silicon comprising reactive gas species.

According to this variant, preferably the precursor compound of the nanostructured silicon is introduced into the reactor as a gas.

### Steps of the Process

According to this variant, the process according to the invention advantageously comprises:
(a1) introducing into the tubular chamber of the reactor at least: the catalyst (optional), and the carbon-based material,
(a2) heating the tubular chamber under carrier gas flow,
(a3) rotating the tubular chamber and/or starting the mixing mechanism,
(b) introducing a reactive silicon-containing gas mixture into the tubular chamber,
(c) controlling the pressure in the chamber of the reactor with the gas mixture flow,
(d) applying a thermal treatment at a temperature ranging from 200° C. to 900° C., under reactive silicon-containing gas mixture flow, in the tubular chamber under rotation and/or mixing,
(e) recovering the obtained product,

According to this variant, most steps have to be accomplished according to this order, however, the rotation and/or mixing at step (a3) can start before or after step (a1) or step (a2).

According to this variant, the thermal treatment of step (d) is applied at low pressure (lower than atmospheric), or at atmospheric pressure or at a pressure superior to atmospheric.

Preferably, when the reactor is a tumbler reactor comprising a rotating and/or a mixing mechanism, the thermal treatment of step (d) is applied at a pressure superior to atmospheric.

### Third Variant

According to a third variant, the method according to the invention is implemented in a vertical fluidized bed reactor.

### Characteristics of the Reactor

The vertical fluidized-bed reactor generally consists in a vertical cylindrical stainless-steel column. The bottom of the column presents a perforated steel plate supporting the powder and providing a homogeneous gas distribution, and a flange which is cooled by water to avoid any premature decomposition of the precursor of nanostructured silicon. At the exit, a high-performance filtration cartridge allows collecting the elutriated particles. The reactor is externally heated by a two-zone electrical furnace and the temperature of its wall is controlled by at least two thermo-couples connected to regulators. Several thermocouples are also placed along the reactor to monitor the axial profile of temperature. Pressure sensors allow to control/monitor the pressure inside the reactor. Flow meters allow to control the different gas flows inside the reactor through the powder.

### Parameters

In a vertical fluidized bed reactor, the method according to the invention can be performed at atmospheric pressure or under a pressure slightly superior to atmospheric. For example, a pressure superior or equal to 1.3. 10⁵ Pa is convenient.

Preferably, the applied temperature ranges from 300° C. to 600° C.

According to this variant, preferably the precursor compound of the nanostructured silicon is introduced into the reactor as a gas.

According to this variant, the catalyst and the carbon-based material have to be under the form of a powder.

### Steps of the Process

(a) introducing into the tubular chamber at least the carbon-based material and the catalyst (optional),
(c) Sealing test: a sealing test is performed on the reactor with nitrogen (1 slm). The sealing test is valid when the pressure stays stable after 1 minute.
(c′) Fluidization of the the catalyst and the carbon-based material: The fluidization is performed using a neutral gas and its flow rate is regularly increased until reaching the desired flow rate. For example, its flow rate is increased of 0.5 slm every two minutes until reaching the desired flow rate.
(d) Applying a thermal treatment: Then, the heating system of the furnace and the cooling system of the flange at the bottom of the bed are started.
(b) After the fluidized bed has reached the isothermal stabilization, the reactive gas is introduced into the chamber.
(e) Recovering the product: At the end of the reaction, the reactor is cooled down before collecting the obtained product. For example, the reactor is cooled to 150° C. or below before the product is recovered.

Most steps have to be accomplished according to this order.

Such a method is disclosed for example in WO2011/137446.

### Step (f)

The process according to the invention comprises (f) at least a step of spheroidization applied to the intermediary silicon-carbon composite material obtained at the end of steps (a) to (e).

The spheroidization step (f) of the method according to the invention aims at modifying the shape, the microstructure, and as a result the physico-chemical properties, of the first silicon-carbon composite material.

The term “spheroidization” or “rounding” used herein means, within the context of the present invention, the process of shape modification and/or surface treatment consisting in applying one or more mechanical stress to the first silicon-carbon-composite material in the form of flakes, in order to obtain a round-shaped material of superior density, compared to the first silicon-carbon-composite material. This process provides smaller particles of silicon-carbon-based composite material wherein the initial flakes have been folded and/or compacted and/or wound and/or rounded many times over, in order to form sphere-like or potato-shaped particles.

In the context of the present invention, the terms “spheroidization” and “rounding” are used synonymously.

Advantageously, the spheroidization comprises at least a step selected from milling, grinding, compacting, densifying, pressing, compressing, folding, winding, rolling, crashing, coarsing, pulverizing, centrifuging, or a mixture of one or more of these steps.

Each step or the combination of one or more of these steps can be carried out in the same spheroidization equipment or in separate equipment.

The spheroidization equipment can for example be selected from: a mortar and pestle, a compaction machine such as, for example, a calender or a press, a mill such as an impact mill, a rotational impact mill, a vortex mill, a vibration mill, a ball mill, a stirring ball mill, a planetary mill, a jet mill, an opposite jet mill, a fluidized bed jet mill, a centrifugal mill, an ultra-centrifugal mill, a pin mill, a hummer mill, a rolling mill, a classifier mill, a downstream classifier mill, a combination of these equipment or any other milling device known to the skilled person.

According to a first favourite embodiment, the spheroidization equipment is a mortar and pestle.

According to another preferred embodiment, the spheroidization equipment is an opposite jet mill.

According to another favourite embodiment, the spheroidization equipment is a rotational impact mill.

According to another favorite embodiment, the spheroidization equipment is a classifier mill or a downstream classifier mill.

According to another embodiment, the spheroidization equipment is an ultra-centrifugal mill.

According to another embodiment, the spheroidization equipment is a ball mill. According to this embodiment, the milling balls can be selected from zirconia milling balls, steel balls, agate milling balls, alumina milling balls, silicon nitride milling balls or mixtures of these balls. Advantageously, the diameter of the milling balls is comprised between 5 and 20 mm. Advantageously, the ratio by volume of the intermediary silicon-carbon composite material to the volume of milling balls and to the volume of empty space in the ball mill is 1:1:1, including a ratio variation around this value of ±20% for each element.

When the spheroidization equipment is selected from mills, it can be a batch mill or a continuous mill.

A “batch mill” is understood to mean, within the meaning of the invention, a mill receiving a discrete quantity of the first silicon-carbon-based composite material to be spheroidized and then discharged. The process is then repeated if needed.

A “continuous mill” is understood to mean, within the meaning of the invention, a mill receiving a continuous flow of the first silicon-carbon-based composite material to be spheroidized and hence can operate on a continuous basis.

Advantageously, the spheroidizing step is performed in a dry environment, i.e., without use of any solvent.

The spheroidization step (f) of the method according to the invention can be carried out at room temperature or at elevated temperature. For example, the spheroidization can be carried out at a temperature from 20° C. to 80° C.

Advantageously, the spheroidization or rounding step is performed during a period of time such that the silicon-carbon-based composite material obtained consists essentially of rounded particles.

Advantageously, the spheroidization or rounding step is performed during a period of time such that the silicon-carbon-based composite material obtained has a tap density that is multiplied by at least a factor of 2, preferably at least a factor of 5, compared to density of the first silicon-carbon-based composite material.

Advantageously, the spheroidization or rounding step is performed during a period of time such that the silicon-carbon-based composite material obtained has a specific surface area that is divided by at least a factor of 2, preferably at least a factor of 4, compared to the specific surface area of the first silicon-carbon-based composite material.

The skilled person is able to adapt the duration of the spheroidization step as well as the parameters of the spheroidizing equipment such as, for example, the rotation speed of the mill, the force of the compaction machine, the temperature, in order to obtain a silicon-carbon-based composite material corresponding to the expected characteristics.

### Additional Steps

According to an embodiment, the method according to the invention further comprises a step (g) of coating at least part of the outer surface of the second silicon-carbon composite material by a second carbon material, different from the flakes of carbon-based material.

Advantageously, the second carbon material is selected from carbon black, acetylene black, graphite, graphene, carbon fibers, carbon nanofibers, carbon nanotubes, and mixtures thereof.

Advantageously, the coating of second carbon material represents a weight ratio of at most 20% by weight, preferably at most 15% by weight, more preferably at most 10% by weight with respect to the total weight of the coated silicon-graphite composite material.

The coating by a second carbon material can be achieved by any method known to a skilled professional, like for example by decomposition of a carbon precursor (acetylene, pitch, sucrose, CMC . . . ), by CVD or thermal treatment.

### The Obtained Materials

### The Intermediary Silicon-Carbon Composite Material

Steps (a) to (d) of the method according to the invention give access to a first silicon-carbon composite material or intermediary silicon-carbon composite material.

Unless otherwise specified, in the following description of the intermediary silicon-carbon composite material, the embodiments apply to all aspects of the invention.

This first silicon carbon-based material comprises, preferably consists essentially of: the carbon-based material, in particular in the form of flakes, and nanostructured silicon. Nanostructured silicon results from chemical vapor decomposition of the precursor compound of nanostructured silicon on the flakes of carbon-based material.

Advantageously, in the intermediary silicon-carbon composite material, silicon content is superior or equal to 5%, preferably superior or equal to 20%, by weight, with respect to the total weight of the first silicon-carbon composite material. Advantageously, silicon content is from 5% to 70%, preferably from 20% to 50% by weight with respect to the total weight of the first silicon-carbon composite material.

The intermediary silicon-carbon composite material may also comprise traces of catalyst or residues of catalyst decomposition.

For example, in the case where a catalyst is used, according to the second and the third aspects of the invention, and in particular where the catalyst is chosen from a metal halide, in particular tin halide such as SnCl₂, the intermediary silicon-carbon composite material may comprise remaining metal halide, in particular tin halide. Remaining tin halide can be partially removed by acidic treatment of the intermediary silicon-carbon composite material.

The intermediary silicon-carbon composite material may also comprise metal particles resulting from the decomposition of the catalyst during the reaction.

In case the catalyst is a metal halide, especially tin halide such as SnCl₂, the intermediary silicon-carbon composite material may also comprise halides as traces.

Preferably catalysts or residues of catalyst decomposition represent 10% or less by weight with respect to the total weight of the intermediary silicon-carbon composite material, preferably 5% or less.

Preferably, the flakes of the silicon-carbon composite material have an aspect ratio of average length to thickness from 2 to 2000, preferably from 2 to 500, more preferably from 2 to 100 and even more preferably from 2 to 50.

Advantageously, the intermediary silicon-carbon composite material has a tap density from 0.01 to 2 g/cm³, preferably from 0.02 to 1 g/cm³ and more preferably from 0.03 to 0.5 g/cm³.

According to a preferred embodiment of the invention, the intermediary silicon-carbon composite material is obtained in the form of flakes decorated by nanostructured silicon.

Preferably, the flakes decorated by nanostructured silicon have the same size as the flakes of the starting carbon-based material.

The nanostructured silicon, resulting from chemical vapor decomposition of the precursor compound, is under any form obtainable by this process, and especially in the form of wires, worms, rods, filaments, sheets or spheres.

According to the first aspect of the invention, the nanostructured silicon is preferably in the form of nanoparticles.

The term “nanoparticle” is understood to mean, within the meaning of the invention, spherical, spheroid or plate shaped elements the diameter of which is nanometric. Nanoparticles can include for example, but not limitatively, nanospheres and nanosheets.

Preferably, the silicon nanoparticles have an average size ranging from 1 nm to 250 nm, more preferentially ranging from 10 nm to 200 nm and more preferentially still ranging from 30 nm to 180 nm. According to the second and the third aspect of the invention, in particular when a catalyst is used in step a) of the method according to the invention, the nanostructured silicon is in the form of nanowires.

The term “nanowire” is understood to mean, within the meaning of the invention, an elongated element, the shape of which is similar to that of a wire and the diameter of which is nanometric. This term encompasses for example but not limitatively nanowires, nanoworms, nanorods, nanofibers and nanofilaments.

Preferably, the silicon nanowires have an average diameter ranging from 1 nm to 250 nm, more preferentially ranging from 10 nm to 200 nm and more preferentially still ranging from 30 nm to 180 nm.

Preferably, the average length of the silicon nanowires ranges from 50 nm to 500 nm.

The characterization of the nanostructured silicon may be implemented by several techniques well known to the skilled professional, such as for example analysis of images obtained by scanning electron microscopy (SEM), or transmission electron microscopy (TEM) from one or more samples of the carbon-silicon composite material.

Nanoworms are a particular, favourite, subgroup of nanowires characterized by their aspect ratio (the ratio of the average length to the average diameter), this aspect ratio being in the lower range of the nanowire group, namely L/D ratio is inferior or equal to 10, more preferably inferior or equal to 5, advantageously inferior or equal to 2.

Preferably, in the intermediary silicon-carbon composite material, the nanostructured silicon is homogeneously dispersed on the surface of the flakes of the carbon-based material. The term “homogeneously dispersed” means that the nanostructured silicon, is uniformly distributed on the surface of flakes of the carbon-based material without one region of it being denser, i.e., containing more silicon, than another.

Advantageously, in the intermediary silicon-carbon composite material, the average ratio of the surface of the carbon-based material covered by nanostructured silicon is 50% or more, preferably 70% or more, more preferably 80% or more.

According to an embodiment, the nanostructured silicon, forms at the surface of the carbon-based material a layer having a thickness inferior to 500 nm, preferably inferior to 200 nm, more preferably inferior to 100 nm.

Advantageously, the nanostructured silicon, forms at the surface of the carbon-based material a layer having a thickness of from 5 nm to 500 nm, preferably from 10 nm to 200 nm, more preferably from 20 nm to 100 nm.

### The Final Silicon-Carbon Composite Material

After step (f) of the method according to the invention a second silicon-carbon composite material or final silicon-carbon composite material is obtained.

Unless otherwise specified, in the following description of the final silicon-carbon composite material, the embodiments apply to all aspects of the invention.

This second silicon carbon-based composite material comprises, preferably consists essentially of: the carbon-based material and nanostructured silicon. The final silicon-carbon composite material may also comprise traces of catalyst or residues of catalyst decomposition.

According to a preferred embodiment, the composition of the final silicon-carbon composite material obtained after step (f) is substantially the same as the composition of the intermediary silicon-carbon composite material obtained after step (e) as described above.

Advantageously, in the final silicon-carbon composite material, silicon content is superior or equal to 5%, preferably superior or equal to 20%, by weight, with respect to the total weight of the final silicon-carbon composite material. Advantageously, silicon content is from 5% to 70%, preferably from 20% to 50% by weight, with respect to the total weight of the final silicon-carbon composite material.

Preferably, at least part of the final silicon-carbon composite material according to the invention is on a micrometric scale.

Preferably, at least part of the final silicon-carbon composite material is in the form of micrometric particles. More preferably, the final silicon-carbon composite material comprises 70% or more, preferably 80% or more, still more preferably 90% or more of micrometric particles.

The spheroidization step (f) of the method according to the invention gives access to micrometric particles of silicon-carbon composite material that have a rounded shape essentially deprived of corners and edges. In particular, the micrometric particles may have a spheroidal shape, a rod like shape and/or a potato like shape.

Advantageously the micrometric particles of the final silicon-carbon composite material are not in the form of flakes. Preferably, in the final silicon-carbon composite material, at most 10%, preferably at most 5% of the micrometric particles are in the form of flakes.

Advantageously, the micrometric particles of the final silicon-carbon composite material have a potato-like shape.

By “potato-like shape”, we refer to particles, generally of irregular shape, having a three-dimensional oblong form with rounded corners having a length to diameter ratio of from 5:1 to 1:1, preferably from 3:1 to 1:1, even more preferably from 2:1 to 1:1.

Advantageously, in the final silicon-carbon composite material, at least 80%, preferably at least 90%, more preferably at least 95%, advantageously 100% of the micrometric particles have a potato like shape.

Advantageously, the micrometric particles of the final silicon-carbon composite material have a narrow size distribution. The skilled person is able to adjust the parameters of the spheroidization step (f) of the method according to the invention, like for example the rotation speed in a mill, the duration of the spheroidization step and/or the characteristics of the spheroidization equipment (for example the diameter of the milling balls in case a ball mill is used), in order to obtain particles with a narrow size distribution. Alternately, a sieving step can be implemented after step f) in order to select microparticles of selected sizes.

The “particle size distribution” or “granulometric dispersion” refers to the relative amount, typically by mass, of particles of the final silicon-carbon composite material present according to their size.

According to a favorite embodiment, the micrometric particles of the final silicon-carbon composite material have a D50 from 5 μm to 50 μm, preferentially from 10 μm to 30 μm and more preferentially from 15 μm to 25 μm.

“D50” also called “median particle diameter” or “median particle size” is the diameter in microns where half of the population of the particles lies below this value and the other half lies over this value. For example, when D50=5 μm for a sample, it means 50% of the particles are larger than 5 μm and 50% of the particles are smaller than 5 μm.

The particles size and morphology and the particle size distribution can be determined by any method known to the skilled person such as, for example, by scanning electron microscopy (SEM), focused ion beam (FIB) tomography, dynamic light scattering (DLS), scanning electron microscopy coupled to energy dispersive x-ray spectrometry (SEM/EDS) and/or by laser diffraction.

Advantageously, the micrometric particles of the final silicon-carbon composite material have a specific surface area of 20 m²/g or less, preferably, of 10 m²/g or less, more preferably of 5 m²/g or less.

By “specific surface area” we refer to the total surface area of the particles of the final silicon-carbon composite particles per unit of mass. The specific surface area of the final composite may be measured by several techniques well known by the skilled person such as for example by Brunauer-Emmett-Teller (BET) adsorption method.

Advantageously, the micrometric particles of the final silicon-carbon composite material have a tap density from 0.05 to 2, preferably from 0.2 to 1.5 g/cm³ and more preferably from 0.35 to 1 g/cm³.

Advantageously, according to an embodiment, especially according to the second aspect of the invention, the micrometric particles of the final silicon-carbon composite material have an internal porosity of from 10% to 60%, more preferably from 15% to 50% and more preferably from 20% to 40%.

According to the first and the third aspects of the invention, preferred, embodiment, the micrometric particles of the final silicon-carbon composite material have an internal porosity of from 5% to 25%.

By “internal porosity” we refer to the percentage of the total volume of the micrometric particles occupied by pores or empty space. The internal porosity of the composite material can be determined by any method known to the skilled person such as for example by mercury intrusion or by density measurement.

Advantageously, for all the aspects of the invention, the micrometric particles of the final silicon-carbon composite material have a closed porosity.

By “closed porosity”, it is meant that the pores of micrometric particle are not interconnected.

The second silicon carbon-based composite material differs from the intermediary material by the arrangement of the carbon-based material and the silicon material. The spheroidization step (f) of the method according to the invention gives access to micrometric particles whose microstructure is different from that obtained with the first silicon-carbon composite material obtained after step (e). In particular, in the micrometric particles obtained after spheroidization, at least part of the nanostructured silicon is embedded inside the carbon-based material, while before the spheroidization step (f), the nanostructured silicon is disposed at the surface of the flakes of carbon-based material.

The term “microstructure” is intended to mean, in the context of the present invention, the way the constituents of the composite material are arranged in relation to each other, in particular nanostructured silicon and the carbon-based material. The microstructure of the composite material can be characterized, for example, by scanning electron microscopy (SEM), transmission electron microscopy (TEM), energy dispersive spectroscopy (EDS), X-ray diffraction (XRD) and/or Raman spectroscopy.

The term “embedded” is intended to mean, in the context of the present invention, that the nanostructured silicon is enclosed in a surrounding matrix of the carbon-based material, in particular between the folds of the carbon material resulting from the spheroidization step.

Advantageously, for all the aspects of the invention, at least 70% by weight, preferably at least 80% by weight, more preferably at least 90% by weight of the nanostructured silicon is embedded in the carbon-based material, the percentage being expressed with respect to the total amount by weight of nanostructured silicon in the second silicon-carbon-based composite material.

Preferably, from 70% to 99% by weight, preferably from 80% to 90% by weight of the nanostructured silicon is embedded in the carbon-based material, the percentage being expressed with respect to the total amount by weight of nanostructured silicon in the second silicon-carbon-based composite material.

Preferably, in the final silicon-carbon composite material, the average ratio of the external surface of particles of carbon-based material covered by nanostructured silicon is from 0% to 20%, preferably from 0% to 10%, more preferably from 0% to 5%.

The applicant has found that these high percentages of the nanostructured silicon embedded in the carbon-based material can be obtained in particular by using carbon-based flakes having a large size, in particular a particle size D50 of from 25 μm to 500 μm, preferably from 30 μm to 500 μm, more preferably from 30 μm to 100 μm, most preferably from 35 μm to 50 μm.

Advantageously, the nanostructured silicon, forms, inside the carbon-based material, layers of material having a thickness of from 5 nm to 500 nm, preferably from 10 nm to 200 nm, more preferably from 20 nm to 100 nm.

### Uses of the Carbon-Silicon Composite Material

The silicon-carbon composite material according to the invention may be used as an anode active material and for the manufacture of a lithium-ion battery.

The final silicon-carbon composite material obtained by the method according to the invention could be used as produced, or after post-production treatments, as silicon-carbon composite anode material in a lithium-ion battery.

The present invention also relates to a method of making an electrode including a current collector, comprising (i) preparing a carbon-silicon composite material according to the method described above, as an electrode active material, and (ii) covering at least one surface of the current collector with a composition comprising said electrode active material.

An electrode including a current collector, can be prepared by a preparation method classically used in the art. For example, the anode active material consisting in the carbon-silicon composite material of the present invention is mixed with a binder, a solvent, and a conductive agent. If necessary, a dispersant may be added. The mixture is stirred to prepare a slurry. Then, the current collector is coated with the slurry and pressed to prepare the anode.

Various types of binder polymers may be used as the binder in the present invention, such as a polyvinylidene fluoride-hexafluoropropylene copolymer (PVDF-co-HEP), polyvinylidene fluoride, polyacrylonitrile, and polymethylmethacrylate.

The electrode may be used to manufacture a lithium secondary battery including a separator and an electrolyte solution which are typically used in the art and disposed between the cathode and the anode.

In particular, the present invention provides a method of making an energy storage device, such as a lithium secondary battery, including a cathode, an anode, and a separator disposed between the cathode and the anode, wherein the anode is obtained by the method of making an electrode as described above.

### BRIEF DESCRIPTION OF THE DRAWINGS

FIG. 1 is a scanning electron microscopy (SEM) micrograph of silicon nanowires (SiNWs)/BNB-90 composite material M1 at low magnification (example 1).

FIG. 2 is a scanning electron microscopy micrograph of BNB-90/SiNWs composite material M1 at high magnification (example 1).

FIG. 3 is an inset chart representing the mean SiNWs diameter distribution of BNB-90/SiNWs composite material M1 (example 1) (X=range of diameter in nm; Y=a.u.).

FIG. 4 is a scanning electron microscopy micrograph of composite material M2 (example 2).

FIG. 5 is a scanning electron microscopy micrograph of graphite M17/SiNWs composite material M3 (example 3).

FIG. 6 is an inset chart representing the mean SiNWs diameter distribution of graphite M17/SiNWs composite material M3 (example 3) (X=range of diameter in nm; Y=a.u.).

FIG. 7 is a scanning electron microscopy micrograph of composite material M4 (example 4).

FIG. 8 shows typical potential profiles for M1 (black) and M2 (gray) materials. The area delimited by the dotted line oval indicates the specific response of Si material.

FIG. 9 shows typical potential profiles for M3 (black) and M4 (gray) materials. The area delimited by the dotted line oval indicates the specific response of Si material.

FIG. 10 shows the reversible capacity for M1 (black) and M2 (gray) materials. Two cells are presented per material.

FIG. 11 shows the reversible capacity for M3 (black) and M4 (gray) materials. Two cells are presented per material.

### EXPERIMENTAL

In the following examples, and unless otherwise indicated, the contents and percentages are given in mass.

### Material

Reactor (fixed bed): stainless steel reactor (intern volume=1 L, diameter=100 mm, height=125 mm),
Ball-milling apparatus: Model PM100, commercialized by Retsch
Centrifugal mill apparatus: Model ZM200 commercialized by Retsch
Nanostructured silicon precursor: diphenylsilane Si (C₆H₅)₂H₂, commercialized by Sigma-Aldrich (CAS Number: 775-12-2),
Catalyst: SnCl₂ commercialized by Strem Chemicals. Inc
Graphite flakes: BNB90 graphite (SSA=21.18 m²/g, D50=43 μm) is commercialized by Imerys, graphite M17 (SSA=24.48 m²/g, D50=16 μm) is commercialized by Nouveau Monde Graphite,
Conductive fillers: graphite powder commercialized by Imerys under the name C-NERGY™ Actilion GHDR-15-4,
Electronic conductive additive: carbon black, commercialized by Imerys under the commercial reference Timcal C-NERGY C65 (CAS Number: 1333-86-4),
Binders: Sodium carboxymethylcellulose (Na-CMC) commercialized by Alfa-Aesar (CAS Number: 9004-32-4), styrene-butadiene rubber (SBR) commercialized by MTI Corporation (CAS Number: 9003-55-8),
Electrolyte: lithium hexaflurorophosphate LiPF_{6 (}1M) dissolved in a mixture of ethylene carbonate (EC) and diethylcarbonate (DEC) (1:1 in volume) comprising 10% by weight of fluoroethylene carbonate (FEC) and 2% by weight of vinylene carbonate (additive), commercialized by Solvionic.

### Example 1: Synthesis of a Batch of BNB-90 Graphite/Silicon Nanowires Material (M1)

### a) Preparation of the BNB-90 Graphite SnCl₂ Material

30 g of BNB-90 is combined to 5 g of SnCl₂ and introduced in a steel bowl of a PM100 ball-milling apparatus. Then, 50 stainless steel balls of 10 mm are introduced in the bowl, then the bowl is tightly closed. The BNB-90-SnCl₂ material is mixed for 10 minutes 30 seconds at 400 rpm.

The BNB-90 graphite/SnCl₂ is simply recovered by extracting the balls with a sieve.

### b) Growth of the Silicon Nanowires (SiNWs)

The BNB-90 graphite/SnCl₂ material obtained at the end of step a) is installed on a glass cup inside the fixed-bed reactor. 250 mL of diphenylsilane, Ph₂SiH₂, are then poured at the bottom of the reactor.

After sealing the reactor, gas lines and temperature heating elements are connected to the reactor. The reactor is then put under vacuum and purged several times with N₂ to remove air/moisture contaminants. Subsequently, the reactor is heated up by means of an electric resistance placed in contact with the exterior surface of the reactor. The heating cycle is as follows: a heating ramp of 90 minutes from 20° C. to 430° C., a plateau of 60 minutes at 430° C., heating is stopped and then the reactor is quenched in water to decrease the temperature to 50° C. in 60 min. The reactor is finally opened to recover the obtained material.

### c) Post-Treatment of the BNB-90 Graphite Silicon Composite Material

The carbonization of the organics coming from Ph₂SiH₂ decomposition is performed by thermal treatment.

The composite material obtained at the end of step b) is placed in crucibles which are then introduced in a horizontal quartz tube furnace. The inlet of the furnace is connected to argon Ar and dihydrogen H₂ gas lines with controlled amounts in a ratio of 97.5:2.5 (v/v) that are continuously flowed over the material. Thermal treatments are performed with a heating ramp of 6° C./min up to a temperature equal to 600° C. for a duration of 2 h, followed by natural cooling. The furnace is finally opened to recover the composite material M1.

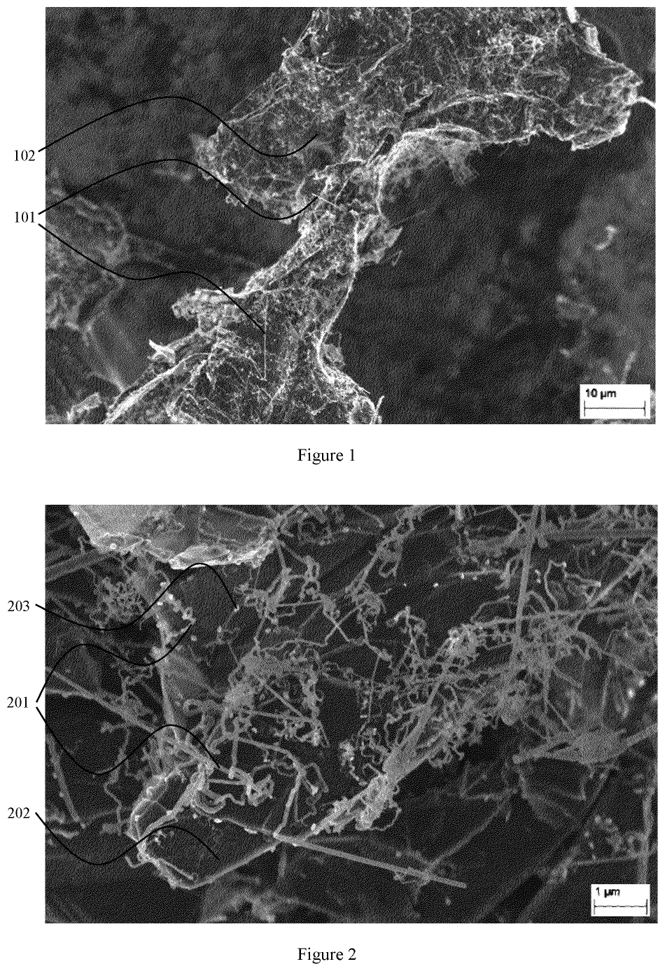

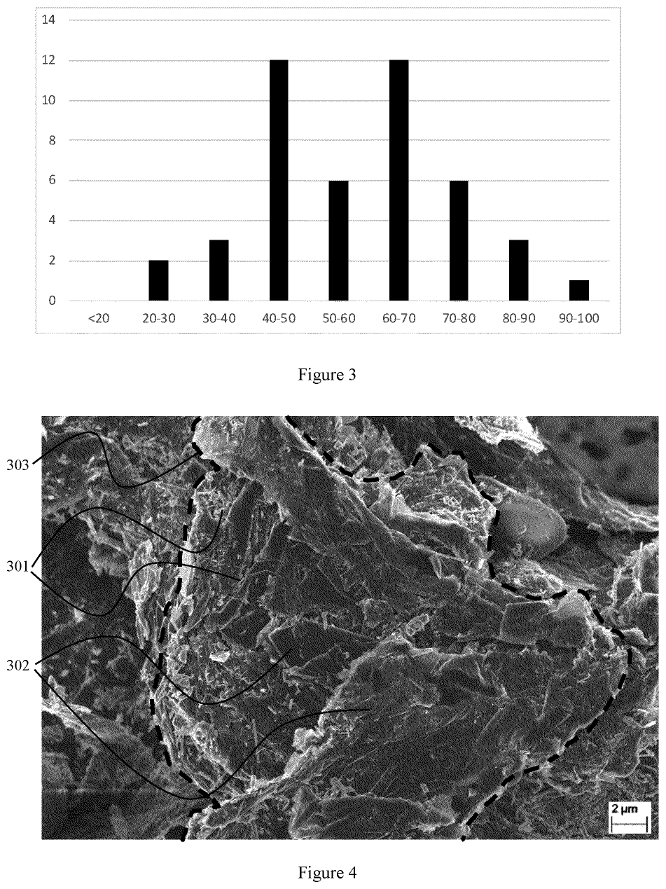

FIGS. 1 and 2 show composite material M1 made of SiNWs 101 and 201 having a mean diameter of 66 nm (see insert chart in FIG. 3 representing the SiNWs diameter distribution), BNB-90 graphite 102 and 202 and particles of tin 203.

### Example 2: Shaping of the Material composite M1 (M2)

### a) Milling

10 g of material composite M1 were introduced in an ultra-centrifugal mill ZM200 apparatus. The material was milled at 6000 rpm and was instantaneously recovered in the cassette pan. The powder was finally sieved at 250 μm.

### b) Compacting

The milled material was then calendered at ca. 7.5 t/cm². The pellet was recovered and finely milled using a mortar. The powder was sieved at 400 um and finally recovered yielding composite material M2.

### c) Description of FIG. 4

FIG. 4 shows composite material M2 made of SiNWs 301 and BNB-90 graphite 302. SiNWs 301 are less predominant on the surface of BNB-90 graphite 302 than observed on M1. This indicates that SiNWs are most likely in the core of the composite material, between graphite flakes. The shaping process leads to the formation of particles presenting an average diameter of 15 μm as represented in black dotted line 303.

### Example 3: Synthesis of a Batch of Graphite M17/Silicon Composite Material (M3)

### a) Preparation of the M17 Graphite SnCl₂ Material

30 g of graphite M17 is combined to 5 g of SnCl₂ and introduced in a stainless-steel bowl PM100 ball-milling apparatus. Then, 50 stainless steel balls of 10 mm are introduced into the bowl. The bowl is then tightly closed. The M17 graphite/SnCl₂ material is mixed for 10 minutes 30 seconds at 400 rpm.

The M17 graphite/SnCl₂ material is simply recovered by extracting the balls with a sieve.

### b) Growth of the Silicon Nanowires

The growth base/pre-catalyst material obtained at the end of step a) is installed on a glass cup inside the fixed-bed reactor. 250 mL of diphenylsilane, Ph₂SiH₂, are then poured at the bottom of the reactor.

After sealing the reactor, gas lines and temperature heating elements are connected to the reactor. The reactor is then put under vacuum and purged several times with N₂ to remove air/moisture contaminants. Subsequently, the reactor is heated up by means of an electric resistance placed in contact with the exterior surface of the reactor. The heating cycle is as follows: a heating ramp of 90 minutes from 20° C. to 430° C., a plateau of 60 minutes at 430° C., heating is stopped and then the reactor is quenched in water to decrease the temperature to 50° C. in 60 min. The reactor is finally opened to recover the obtained material.

### c) Post-Treatment of the Growth Base Silicon Composite Material

The carbonization of the organics coming from Ph₂SiH₂ decomposition is performed by thermal treatment.

The composite material obtained at the end of step b) is placed in crucibles which are then introduced in a horizontal quartz tube furnace. The inlet of the furnace is connected to argon Ar and dihydrogen H₂ gas lines with controlled amounts in a ratio of 97.5:2.5 (v/v) that are continuously flowed over the material. Thermal treatments are performed with a heating ramp of 6° C./min up to a temperature equal to 600° C. for a duration of 2 h, followed by natural cooling. The furnace is finally opened to recover the composite material M3.

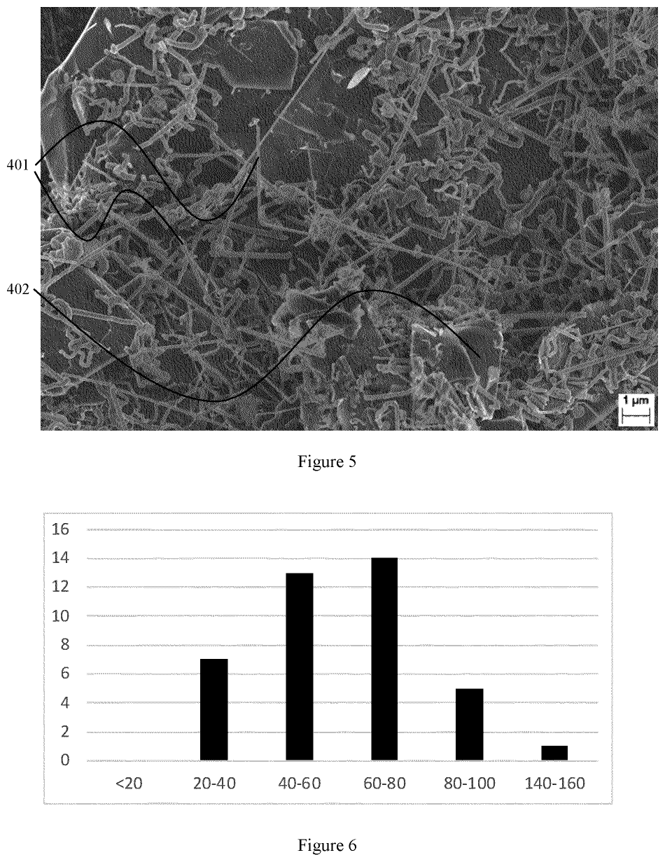

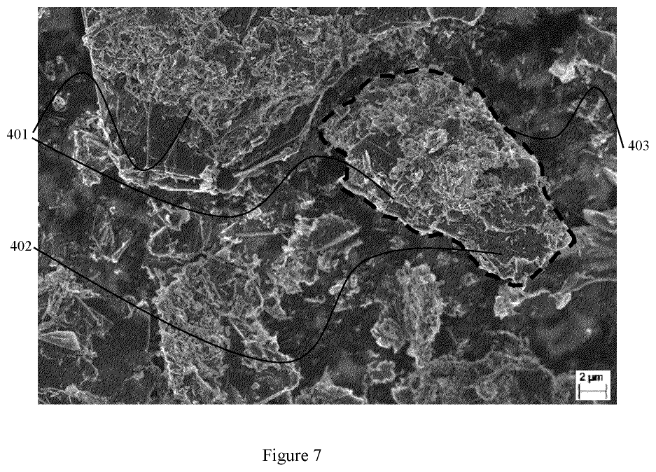

FIG. 5 shows composite material M3 with SiNWs 401 having a mean diameter of 77 nm (see insert chart in FIG. 6 representing the SiNWs diameter distribution) on M17 graphite 402.

### Example 4: Shaping Material Composite M3 (M4)

### a) Milling

10 g of composite material M3 were introduced in an ultra-centrifugal mill ZM200 apparatus. The material was milled at 6000 rpm and was instantaneously recovered in the cassette pan. The powder was finally sieved at 250 μm.

### b) Compacting

The milled material was then calendered at ca. 7 t/cm². The pellet was recovered and finely milled using a mortar. The powder was finally recovered yielding composite material M4.

### c) Description of FIG. 7

FIG. 7 shows composite material M4 made of SiNWs 501 and graphite M17 502. Si NWs 501 are less predominant on the surface of M17 graphite 502 than seen on M3. This indicates that SiNWs are most likely in the core of the composite material, between graphite flakes. The shaping process leads to the formation of secondary particles presenting an average diameter of 15 μm as represented in black dotted line 503.

### Example 5: Preparation of the Electrodes for Lithium Batteries

The electrochemical characterization of all prepared materials M1, M2, M3 and M4, respectively issued as Examples 1, 2, 3 and 4, was conducted by preparing coin-cells wherein the anode comprised one of the prepared materials as active material.

### a) Mixing with Conductive Fillers

The starting composite material obtained at the end was mixed with graphite powder using yttria-stabilized zirconia (YSZ) grinding balls, in an IKA® Ultra-Turrax disperser using ST-20 dispersing tubes. The composite material and the graphite were introduced into the disperser according to a weight ratio equal to 38:62. 12 g of 3 mm diameter YSZ balls were used for 10 minutes at rotational speed 7.5.

The mixed material was finally recovered for further processing or characterization.

### b) Preparation of a Coin-Cell

As described above, the synthesized material was mixed with graphite powder (IMERYS Actilion GHDR-15-4) at a ratio of ca. 38:62 to form the electrode active material. The weight ratios are 95:1:4 for the active material:C65:binders. For all systems, 1 wt % of carbon black was added as an electronic conductive additive, along with 2 wt % sodium carboxymethyl cellulose (Na-CMC) and 2 wt % styrene-butadiene rubber (SBR) used as binders. Deionized water was employed as solvent. Water is added to reach a viscosity allowing electrode processing, yielding to a dry content of about 40 wt %. Wet mixing was done for all materials for 30 minutes at speed 5. Each electrode ink was cast on a copper foil of 20 μm using a doctor blade. After partial drying in air, the electrodes were further dried at 65° C. in an oven for 1 hour. The electrodes were then cut into discs of 14 mm diameter, calendered at ca. 0.6 t/cm² and weighed, and were finally dried overnight in vacuum at 110° C.

Half coin-cells (Kanematsu KGK Corp®, stainless steel 316 L) were prepared inside an Ar glovebox using metallic Li as counter and reference electrodes, a layer of Whatman glass fiber and a layer of Celgard 2325 separator, and the electrode of interest. The electrolyte purchased from Solvionic® was used to impregnate the electrode and separator materials. Its formula was 1 M LiPF₆ dissolved in EC:DEC (1/1 v/v) with 10 wt % FEC (fluoroethylene carbonate) and 2 wt % VC (vinylene carbonate) additives. The cell was subsequently sealed with an automated press and taken out of the glovebox to be measured on a battery cycler. Seven formation cycles were performed prior to regular cycling at 1 C-rate. The formation cycles are made of 2 cycles at C/7 and 5 cycles at C/5 using galvanostatic and potentiostatic discharging (lithiation), and galvanostatic charging (delithiation). Subsequently, similar cycling at 1 C was performed for 22 cycles.

### c) Determination of the Electrochemical Performances

The performances of the cells are determined by galvanostatic cycling using a Biologic BCS-805 cycling system equipped with 8 ways, each of the 8 ways comprising 2 different electrodes.

### 1—Potential Profile

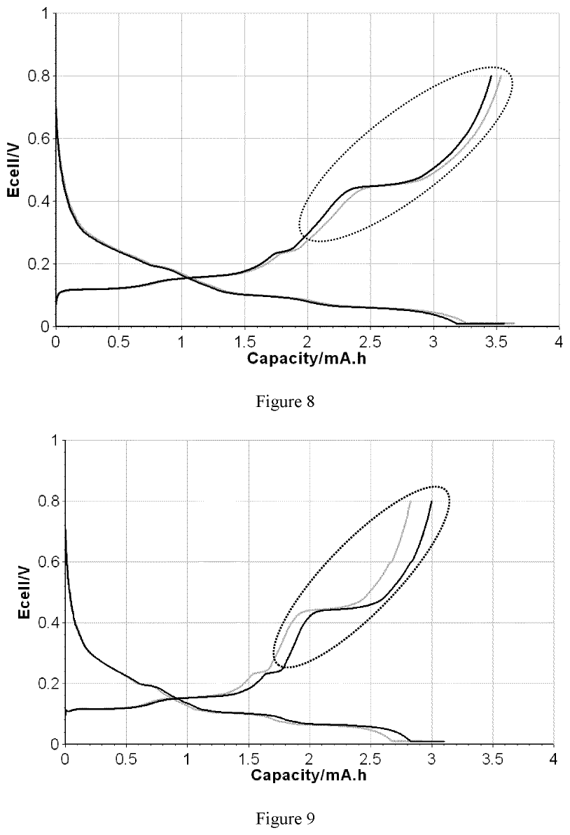

FIGS. 8 and 9 represent the potential profiles obtained from cells C1, C2, C3 and C4 recorded during the second cycle at C/7 (second formation cycle), respectively for M1, M2, M3 and M4 materials. For all materials we observe that the potential profile of the cells obtained from composite materials M1, M2, M3, M4 show the cumulation of the electrochemical activity of graphite and silicon materials, which evidences that the composite materials are electrically and electrochemically active. The response from graphite is exclusively measured below 0.3 V during lithiation (discharge) or delithiation (charge). In the case of Si, looking at the delithiation (charge) profiles, its electrochemical activity spreads from 0.1 to 0.8 V. Given the reaction mechanism of Si with Li ions ultimately forming crystalline cubic Li₁₅Si₄ phase at the end of lithiation, the delithiation (charge) is accompanied with an unambiguously characteristic inflexion/plateau near 0.45 V during charge (delithiation). This plateau is well-visible after the shaping of the materials from M1 to M2, and from M3 to M4, which demonstrates that the shaping of the materials does not prevent nor reduce the electrochemical activity of Si nanomaterials.

### 2—Reversible Capacity

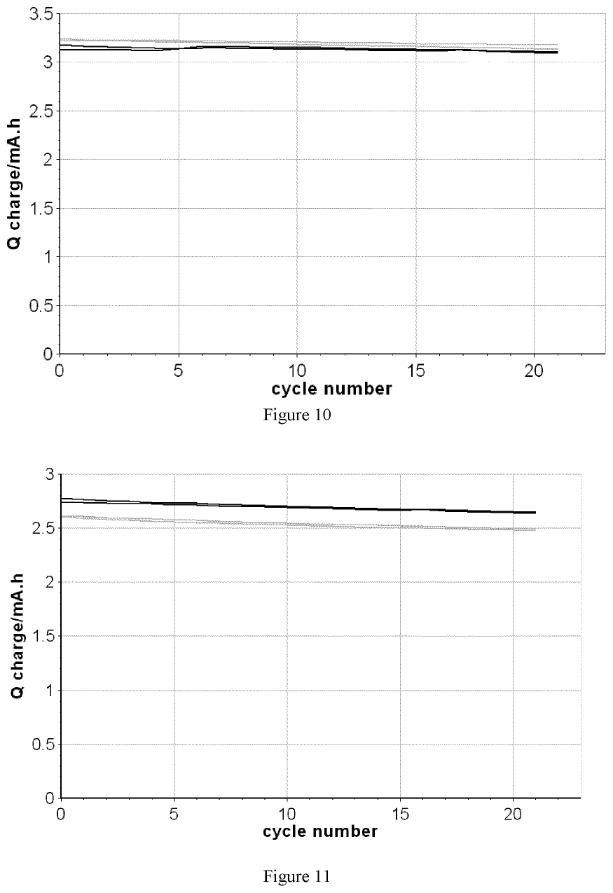

FIGS. 10 and 11 represent the reversible capacities obtained from cells C1, C2, C3 and C4 recorded during the cycling at 1 C, respectively for M1, M2, M3 and M4 materials. The cycle life curves show very similar shape and slopes, which indicates that the shaping of the materials does not adversely affect the materials performances. The CR values presented below, which are the ratio of the capacity at cycle n divided by the capacity of cycle n−1, are derived from theses curves, and further support that the shaping step f) does not decrease the durability of the material.

### 3—Values of the Initial Reversible Capacity (ICE), Coulombic Efficiency (CE) and Capacity Retention (CR)

The potential profiles of the cells C1, C2, C3 and C4 based respectively on materials M1, M2, M3 and M4, have been obtained during the cycling at C/7 and subsequent cycling at C/5 and 1 C by measuring the potential of the cell as a function of its capacity. The initial reversible capacity and the coulombic efficiency derived from the measurements at C/7 during the first cycles, and the CE and CR values obtained during the cycling at 1 C are given in Table 1.

TABLE 1

| Cell | C1 | C2 | C3 | C4 |
|---|---|---|---|---|
| Initial capacity (mA · h/g) | 799 | 847 | 761 | 805 |
| Electrode capacity (mA · h/g) | 497 | 514 | 483 | 499 |
| ICE (%) | 75.4 | 74.4 | 79.9 | 80.2 |
| Average CE cycle #10 (%) | 99.21 | 99.50 | 99.20 | 99.47 |
| Average CE cycle #20 (%) | 99.18 | 99.51 | 99.22 | 99.47 |
| Average CR cycle #10 (%) | 99.92 | 99.88 | 99.77 | 99.76 |
| Average CR cycle #20 (%) | 99.87 | 99.91 | 99.78 | 99.83 |

The cell C2 prepared from composite material M2 presents a higher initial capacity (847 mA·h/g) than the cell C1 prepared from composite material M1 (799 mA·h/g). This means that composite material M2 presents a slightly higher silicon active content than M1, which can result from a better physical contact between Si and graphite materials. Moreover, a comparison between C1 and C2 reveals an improvement of the average coulombic efficiency at cycles 10 and 20 of ca. 0.3% (99.21/99.18% vs. 99.50/99.51%, respectively) with a quasi-identical average capacity retention of ca. 99.9% at cycles 10 and 20 (99.92/99.87% vs. 99.88/99.91%, respectively). Overall, the CE results demonstrate that the shaping process applied to composite material M1 yields composite material M2 having an improved surface protection and stability of silicon due to its insertion between graphite flakes while the CR results demonstrate that the silicon nanoobject materials keep their mechanical durability during repeated cycling.

The cell C4 prepared from composite material M4 presents a higher initial capacity (805 mA·h/g) than the cell C3 prepared from composite material M3 (761 mA·h/g). Therefore, composite material M4 presents a slightly higher silicon active content than M3, which can result from a better physical contact between Si and graphite materials. Moreover, a comparison between C3 and C4 reveals an improvement of the average coulombic efficiency at 10 and 20 cycles of ca. 0.25% (99.20/99.22% and 99.47/99.47%, respectively) with a slightly better capacity retention at 20 cycles (99.77/99.78 and 99.76/99.83, respectively). Overall, these results demonstrate that the shaping process applied to composite material M3 yields composite material M4 having an improved surface protection and stability of Si due to its insertion between graphite flakes while the CR results demonstrate that the silicon nanoobject materials keep their mechanical durability during repeated cycling.

Moreover, as the increase in CE will translate into the lower consumption of Li in a full cell containing a cathode possessing a limited Li capacity (e.g., NMC622), the cycle life of full cell batteries containing shaped materials M2 and M4 will be superior to that of cells based on unshaped materials.

It should be noted that the CE of the anode material is a key parameter for enabling long term cyclability of Li-ion batteries. Using the formula CEⁿ=capacity retention, where n is the cycle number and CE accounts for the coulomb losses on the anode solely, the losses of an anode having a CE of 99% that would be placed in a full cell with a limited capacity cathode material (e.g., NMC622, etc), would lead to 37% remaining capacity after 100 cycles. Similarly, an anode with a superior CE of 99.5% will lead to a full cell capacity retention of ca. 60% after 50 cycles, and further increasing the anode CE to 99.9% would give an estimated 90% full cell capacity retention. It is thereby crucial to design anode materials with superior CE.

### Bibliography

^{[1]} a) M. Holzapfel, H. Buqa, F. Krumeich, P. Novák, F.-M. Petrat, C. Veit Chemical Vapor Deposited Silicon/Graphite Compound Material as Negative Electrode for Lithium-Ion Batteries, Electrochemical and Solid-State Letters, 2005, 8(10), A516-A520. b) Bei Liu, Peng Huang, Zhiyong Xie, Qizhong Huang Large-Scale Production of a Silicon Nanowire/Graphite Composites Anode via the CVD Method for High-Performance Lithium-Ion Batteries, Energy & Fuels 2021, 35, 2758-2765.
^{[2]} Sui D, Xie Y, Zhao W, et al. A high-performance ternary Si composite anode material with crystal graphite core and amorphous carbon shell. J Power Sources. 2018, 384, 328-333.
^{[3]} Liu W, Zhong Y, Yang S, et al. Electrospray synthesis of nano-Si encapsulated in graphite/carbon microplates as robust anodes for high performance lithium-ion batteries. Sustain Energy Fuels. 2018; 2(3), 679-687.
^{[4]} Wang A, Liu F, Wang Z, Liu X. Self-assembly of silicon/carbon hybrids and natural graphite as anode materials for lithium-ion batteries. RSC Adv. 2016; 6(107), 104995-105002.
^{[5]} Uono H, Kim BC, Fuse T, Ue M, Yamaki J. Optimized structure of silicon/carbon/graphite composites as an anode material for Li-ion batteries. J Electrochem Soc. 2006; 153(9), A1708-A1713.
^{[6]} Lee JH, Kim WJ, Kim JY, Lim SH, Lee SM. Spherical silicon/graphite/carbon composites as anode material for lithium-ion batteries. J Power Sources. 2008; 176(1), 353-358.
^{[7]} Jo YN, Kim Y, Kim JS, et al. Si-graphite composites as anode materials for lithium secondary batteries. J Power Sources. 2010; 195(18), 6031-6036.

1-19. (canceled)

20. A method for the preparation of a silicon-carbon composite material, said method comprising:
a) introducing into a chamber of a reactor at least: flakes of a carbon-based material and optionally a catalyst,
b) introducing into the chamber of the reactor at least a precursor compound of nanostructured silicon,
c) decreasing the dioxygen content in the chamber of the reactor,
d) applying a thermal treatment at a temperature ranging from 200° C. to 900° C.,
e) recovering a first silicon-carbon composite material,
f) applying a spheroidization step to the product obtained in step (e) to obtain a second silicon-carbon composite material.

21. The method according to claim 20, wherein the flakes of carbon-based material have a particle size D50 of from 25 μm to 500 μm.

22. The method according to claim 21, wherein the second silicon-carbon composite material has an internal porosity of from 5% to 25%.

23. The method according to claim 20, wherein the nanostructured silicon is in the form of nanoparticles.

24. The method according to claim 23, wherein the nanoparticles have a diameter ranging from 1 nm to 250 nm.

25. The method according to claim 20, wherein in step a) a catalyst is introduced into the chamber of the reactor and the catalyst is chosen from metals, metallic oxides and metallic halides.

26. The method according to claim 25, wherein the catalyst is selected from gold (Au), tin (Sn), tin dioxide (SnO₂), tin halide (SnX₂) and mixtures thereof.

27. The method according to claim 25, wherein the nanostructured silicon is in the form of nanowires or nanofibers.

28. The method according to claim 20, wherein in the first silicon-carbon composite material, the average ratio of the surface of the carbon-based material covered by nanostructured silicon is 50% or more.

29. The method according to claim 20, wherein in the second silicon-carbon composite material, the average ratio of the external surface of the material covered by nanostructured silicon is 20% or less.

30. The method according to claim 20, wherein steps (a) to (e) are implemented in a fixed-bed reactor.

31. The method according to claim 20, wherein the spheroidization step (f) comprises at least a step selected from milling, grinding, compacting, densifying, compressing, pressing, folding, winding, rolling, crashing, coarsing, pulverizing, centrifuging or a mixture of one or more of these steps.

32. The method according to claim 20, wherein at least part of the second silicon-carbon composite material is in the form of micrometric particles having a D50 between 5 and 50 μm.

33. The method according to claim 32, wherein the micrometric particles of the second silicon-carbon composite material have a potato-like shape.

34. The method according to claim 32, wherein the micrometric particles have a specific surface area of 20 m²/g or less.

35. The method according to claim 20, wherein the carbon-based material is selected from graphite, graphene, and carbon.

36. The method according to claim 20, wherein the precursor compound of the silicon particles is a silane compound or a mixture of silane compounds.

37. The method according to claim 20, further comprising after step f) a step of coating the outer surface of the second material by a second carbon material, different from the flakes of carbon-based material.

38. A method of making an electrode including a current collector, said method comprising (i) preparing a carbon-silicon composite material according to the method of claim 20, as an electrode active material, and (ii) covering at least one surface of the current collector with a composition comprising said electrode active material.

39. A method of making an energy storage device including a cathode, an anode, and a separator disposed between the cathode and the anode, wherein at least one of the electrodes is obtained by the method of claim 38.
